(19) United States
(12) Patent Application Publication
(10) Pub. No.: US 2025/0096821 A1
(43) Pub. Date: Mar. 20, 2025

(54) SYSTEM AND METHOD TO ENABLE LOW BAND DOWNLINK CARRIER AGGREGATION

(71) Applicant: Apple Inc., Cupertino, CA (US)

(72) Inventors: Bradley D. Scoles, Morgan Hill, CA (US); Qishan Yu, San Jose, CA (US); Christopher J. Huber, North Reading, MA (US)

(21) Appl. No.: 18/745,278

(22) Filed: Jun. 17, 2024

Related U.S. Application Data
(60) Provisional application No. 63/583,574, filed on Sep. 18, 2023.

(51) Int. Cl. H04B 1/00; H04B 1/40

(52) U.S. Cl. CPC H04B 1/0057; H04B 1/40

(57) ABSTRACT

In an electronic device, a transmitter and a receiver may each be coupled to one or more antennas to enable the electronic device to both transmit and receive wireless signals. The electronic device may include two or more antennas coupled to a radio frequency front end module that receives different downlink signals on different frequency bands. For example, a switch may couple a first antenna to a first duplexer to support transmitting and/or receiving signals within a first frequency band and a second antenna to a second duplexer to support transmitting and/or receiving signals within a second frequency band. As such, the electronic device may concurrently transmit and/or receive two signals having different frequencies, which may improve downlink throughput and/or support downlink carrier aggregation.

### CROSS-REFERENCE TO RELATED APPLICATION

This application claims priority to U.S. Provisional Application No. 63/583,574, filed Sep. 18, 2023, entitled “SYSTEM AND METHOD TO ENABLE LOW BAND DOWNLINK CARRIER AGGREGATION,” which is hereby incorporated by reference herein in its entirety for all purposes.

### BACKGROUND

The present disclosure relates generally to wireless communication, and more specifically to increasing wireless communication throughput.

In an electronic device, a transmitter and a receiver may each be coupled to an antenna to enable the electronic device to both transmit and receive wireless signals. For example, the electronic device may transmit a first signal having a first frequency via the antenna at a first time and receive a second signal having a second frequency via the antenna at a second time. However, throughput of the signals may be limited by the antenna.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, an electronic device includes a first antenna and a second antenna. The electronic device also includes a first receiver including a first low noise amplifier and a second receiver including a second low noise amplifier. The electronic device also includes a first duplexer coupled to the first low noise amplifier and a second duplexer coupled to the second low noise amplifier. Additionally, the electronic device includes a switch coupled to the first antenna and the second antenna. Further, the electronic device includes processing circuitry configured to cause the switch to couple the first duplexer to the first antenna, cause the switch to couple the second duplexer to the second antenna, cause the first receiver to receive a first signal having a first frequency in a first frequency band via the first antenna, and cause the second receiver to receive a second signal having a second frequency in a second frequency band via the second antenna while the first receiver receives the first signal.

In another embodiment, a method for wireless communications includes causing, via processing circuitry, an antenna switch to couple a first antenna to a first duplexer configured to enable transmission or reception of signals having a first frequency within a first frequency band. The method also includes causing, via the processing circuitry, the antenna switch to couple a second antenna to a second duplexer configured to enable transmission or reception of signals having a second frequency within a second frequency band. Additionally, the method includes receiving, via the processing circuitry and the first antenna, a first signal having the first frequency. Further, the method includes receiving, via the processing circuitry and the second antenna, a second signal having the second frequency while receiving the first signal.

In yet another embodiment, an electronic device includes two or more antennas and a plurality of duplexers coupled to the two or more antennas and configured to enable transmission or reception of signals on a first frequency band and a second frequency band. The electronic device also includes at least one receiver coupled to at least one low noise amplifier. Additionally, the electronic device includes a switch coupled to the two or more antennas. Further, the electronic device includes processing circuitry configured to cause the switch to couple a first duplexer of the plurality of duplexers to a first antenna of the two or more antennas, cause the switch to couple a second duplexer of the plurality of duplexers to a second antenna of the two or more antennas, and cause the at least one receiver to concurrently receive a first signal having a first frequency on the first frequency band via the first antenna and a second signal having a second frequency on the second frequency band via the second antenna.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a functional diagram of the electronic device of FIG. 1, according to embodiments of the present disclosure;

FIG. 3 is a schematic diagram of a transmitter of the electronic device of FIG. 1, according to embodiments of the present disclosure;

FIG. 4 is a schematic diagram of a receiver of the electronic device of FIG. 1, according to embodiments of the present disclosure;

FIG. 5 is a schematic diagram of a communication system including the electronic device of FIG. 1 communicatively coupled to a wireless communication network supported by base stations, according to embodiments of the present disclosure;

FIG. 6 is a schematic diagram of a radio frequency front end (RFFE) module of the electronic device of FIG. 1, according to embodiments of the present disclosure; and

FIG. 7 is a flowchart of a method for concurrently receiving two signals via at least two antennas of the RFFE module of FIG. 6, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed to transmitting and/or receiving wireless signals via antennas of an electronic device. Embodiments herein provide various apparatuses and techniques to enable transmitting and receiving wireless signals via two or more antennas of the electronic device. For example, the electronic device may include one or more switches that couple a first antenna to a first duplexer, a second antenna to a second duplexer, and/or a third antenna to a third duplexer. The one or more switches may include a three-pole, double throw switch that is coupled to the three antennas selects two of the three antennas (to operate concurrently). In particular, the one or more switches may couple (e.g., selectively couple) the first antenna to the first duplexer that supports transmitting and/or receiving signals on a first frequency band and concurrently (e.g., simultaneously) couple the second antenna to the second duplexer that supports transmitting and/or receiving signals on a second frequency band. Additionally or alternatively, the one or more switches may select the third antenna for transmitting and/or receiving. For example, the one or more switches may uncouple the first antenna or the second antenna and couple the third antenna to the third duplexer that supports transmitting and/or receiving signals on a third frequency band. In this way, the electronic device may include at least two antennas that concurrently transmit and/or receive two signals on two different frequency bands. The first duplexer, the second duplexer, and/or the third duplexer may be coupled to respective low noise amplifiers that receives the signals and transmits the signals to additional switching circuitry that may direct the signals to an appropriate receiver. As such, the electronic device may concurrently transmit and/or receive signals on at least two antennas at one time. Accordingly, throughput of the electronic device may be improved.

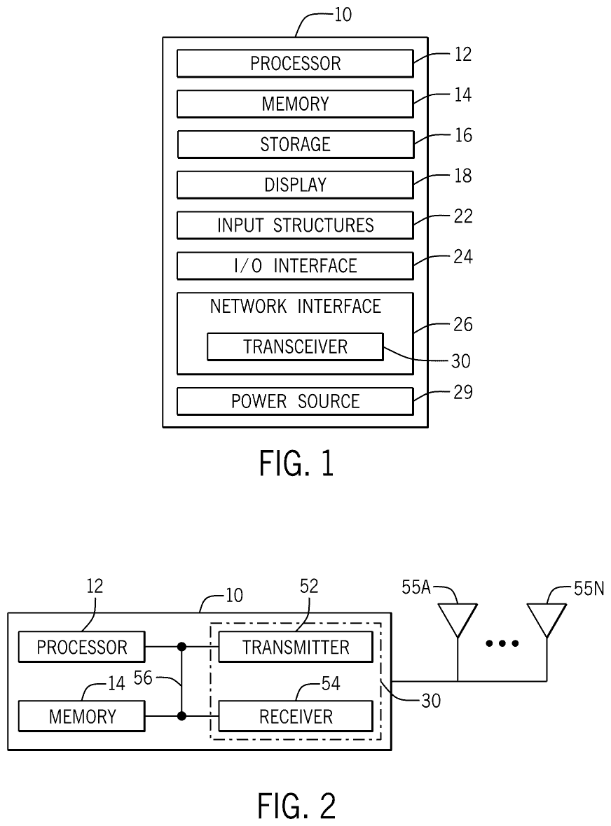

FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, and other similar devices. In additional or alternative embodiments, the electronic device 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, Long Term Evolution® (LTE) cellular network, Long Term Evolution License Assisted Access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. The power source 29 of the electronic device 10 may include any suitable source of power, such as a rechargeable lithium polymer (Li-poly) battery and/or an alternating current (AC) power converter.

FIG. 2 is a functional diagram of the electronic device 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) may be communicatively coupled directly or indirectly (e.g., through or via another component, a communication bus, a network) to one another to transmit and/or receive signals between one another.

The electronic device 10 may include the transmitter 52 and/or the receiver 54 that respectively enable transmission and reception of signals between the electronic device 10 and an external device via, for example, a network (e.g., including base stations or access points) or a direct connection. As illustrated, the transmitter 52 and the receiver 54 may be combined into the transceiver 30. The electronic device 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The electronic device 10 may include multiple transmitters, multiple receivers, multiple transceivers, and/or multiple antennas as suitable for various communication standards. In some embodiments, the transmitter 52 and the receiver 54 may transmit and receive information via other wired or wireline systems or means. For example, a first antenna 55A may be selectively coupled to a first duplexer that supports transmitting and/or receiving signals on a first frequency band via a first switch and a second antenna 55B may be selectively coupled to a second duplexer that supports transmitting and/or receiving signals on a second frequency band via a second switch. As such, the electronic device 10 may include at least two antennas that concurrently transmit and/or receive two signals on two different frequency bands, thereby improving throughput of the electronic device 10.

As illustrated, the various components of the electronic device 10 may be coupled together by a bus system 56. The bus system 56 may include a data bus, for example, as well as a power bus, a control signal bus, and a status signal bus, in addition to the data bus. The components of the electronic device 10 may be coupled together or accept or provide inputs to each other using some other mechanism.

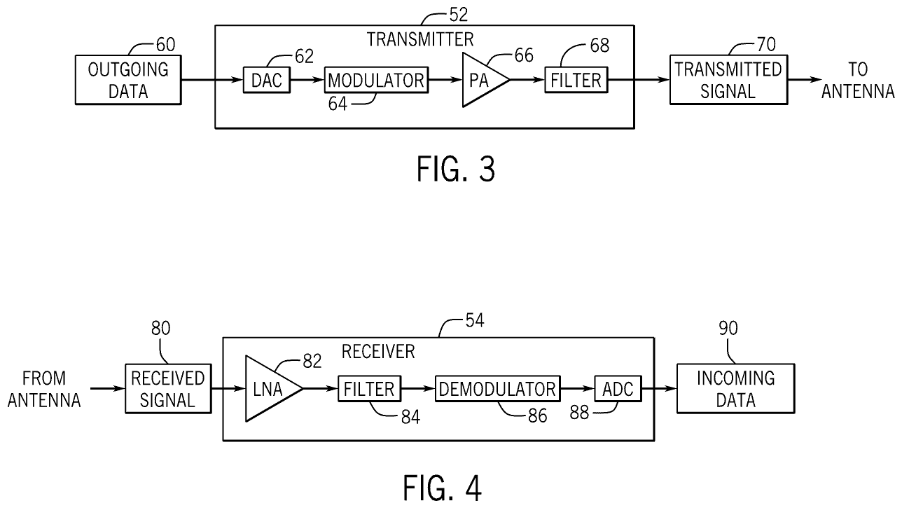

FIG. 3 is a schematic diagram of the transmitter 52 (e.g., transmit circuitry), according to embodiments of the present disclosure. As illustrated, the transmitter 52 may receive outgoing data 60 in the form of a digital signal to be transmitted via the one or more antennas 55. A digital-to-analog converter (DAC) 62 of the transmitter 52 may convert the digital signal to an analog signal, and a modulator 64 may combine the converted analog signal with a carrier signal to generate a radio wave. A power amplifier (PA) 66 receives the modulated signal from the modulator 64. The power amplifier 66 may amplify the modulated signal to a suitable level to drive transmission of the signal via the one or more antennas 55. A filter 68 (e.g., filter circuitry and/or software) of the transmitter 52 may then remove undesirable noise from the amplified signal to generate transmitted signal 70 to be transmitted via the one or more antennas 55. The filter 68 may include any suitable filter or filters to remove the undesirable noise from the amplified signal, such as a bandpass filter, a bandstop filter, a low pass filter, a high pass filter, and/or a decimation filter.

The power amplifier 66 and/or the filter 68 may be referred to as part of a radio frequency front end (RFFE), and more specifically, a transmit front end (TXFE) of the electronic device 10. Additionally, the transmitter 52 may include any suitable additional components not shown, or may not include certain of the illustrated components, such that the transmitter 52 may transmit the outgoing data 60 via the one or more antennas 55. For example, the transmitter 52 may include a mixer and/or a digital up converter. As another example, the transmitter 52 may not include the filter 68 if the power amplifier 66 outputs the amplified signal in or approximately in a desired frequency range (such that filtering of the amplified signal may be unnecessary).

FIG. 4 is a schematic diagram of the receiver 54 (e.g., receive circuitry), according to embodiments of the present disclosure. As illustrated, the receiver 54 may receive received signal 80 from the one or more antennas 55 in the form of an analog signal. A low noise amplifier (LNA) 82 may amplify the received analog signal to a suitable level for the receiver 54 to process. A filter 84 (e.g., filter circuitry and/or software) may remove undesired noise from the received signal, such as cross-channel interference. The filter 84 may also remove additional signals received by the one or more antennas 55 that are at frequencies other than the desired signal. The filter 84 may include any suitable filter or filters to remove the undesired noise or signals from the received signal, such as a bandpass filter, a bandstop filter, a low pass filter, a high pass filter, and/or a decimation filter. The low noise amplifier 82 and/or the filter 84 may be referred to as part of the RFFE, and more specifically, a receiver front end (RXFE) of the electronic device 10.

A demodulator 86 may remove a radio frequency carrier signal and/or extract a demodulated signal (e.g., an envelope signal) from the filtered signal for processing. An analog-to-digital converter (ADC) 88 may receive the demodulated analog signal and convert the signal to a digital signal of incoming data 90 to be further processed by the electronic device 10. Additionally, the receiver 54 may include any suitable additional components not shown, or may not include certain of the illustrated components, such that the receiver 54 may receive the received signal 80 via the one or more antennas 55. For example, the receiver 54 may include a mixer and/or a digital down converter.

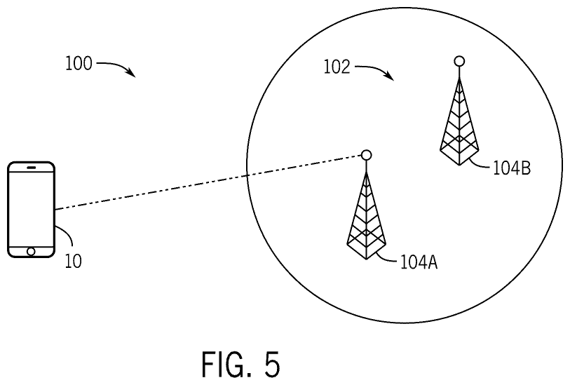

FIG. 5 is a schematic diagram of a communication system 100 including the electronic device 10 (e.g., user equipment) communicatively coupled to a wireless communication network 102 supported by base stations 104A, 104B (collectively 104), according to embodiments of the present disclosure. In particular, the base stations 104 may include Next Generation NodeB (gNodeB or gNB) base stations and may provide 5G/NR coverage via the wireless communication network 102 to the electronic device 10. The base stations 104 may include any suitable electronic device, such as a communication hub or node, that facilitates, supports, and/or implements the network 102. In some embodiments, the base stations 104 may include Evolved NodeB (eNodeB) base stations and may provide 4G/LTE coverage via the wireless communication network 102 to the electronic device 10. Each of the base stations 104 may include at least some of the components of the electronic device 10 shown in FIGS. 1 and 2, including one or more processors 12, the memory 14, the storage 16, the transceiver 30, the transmitter 52, the receiver 54, and the associated circuitry shown in FIGS. 3 and 4. It should be understood that while the present disclosure may use 5G/NR as an example specification or standard, the embodiments disclosed herein may apply to other suitable specifications or standards (e.g., such as the 4G/LTE specification, a sub-4G specification, a beyond 5G specification, such as a 6G specification, and so on). Moreover, the network 102 may include any suitable number of base stations 104 (e.g., one or more base stations 104, four or more base stations 104, ten or more base stations 104, and so on).

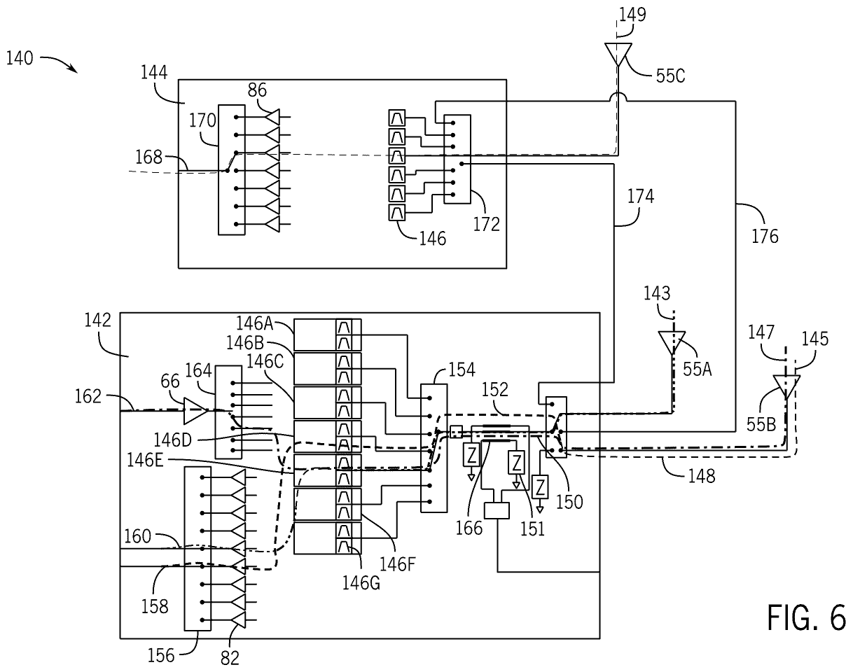

Keeping the foregoing in mind, FIG. 6 is a schematic diagram of a radio frequency front end (RFFE) module 140 of the electronic device 10, according to embodiments of the present disclosure. As illustrated, the RFFE module 140 may include first RFFE circuitry 142 communicatively coupled to a first antenna 55A and a second antenna 55B and second RFFE circuitry 144 communicatively coupled to a third antenna 55C. Although not illustrated, RFFE module 140 may be at least partially disposed within transceiver 30 and/or communicatively coupled to the processor 12. In particular, the first RFFE circuitry 142 and the second RFFE circuitry 144 may include components coupled to or integrated with one or more transmitters 52 and/or one or more receivers 54. As such, the first RFFE circuitry 142 and/or the second RFFE circuitry 144 may transmit and/or receive signals to and from the processor 12.

As illustrated by FIG. 6, the first RFFE circuitry 142 may include a first receive chain (e.g., path) 143, a second receive chain 145, and a transmission chain 147 while the second RFFE circuitry 144 may include a third receive chain 149. The first receive chain 143 may include the first antenna 55A, an antenna switch 148, a first connection 150 or a second connection 152, a frequency band switch 154, a respective duplexer 146E, a respective LNA 82, an LNA switch (e.g., switching circuitry) 156, a first LNA output 158 or a second LNA output 160, and the processor 12. The second receive chain 145 may include, for example, a second antenna 55B, the antenna switch 148, the first connection 150 or the second connection 152, the frequency band switch 154, a respective duplexer 146D, a respective LNA 82, the LNA switch 156, the first LNA output 158 or the second LNA output 160, and the processor 12. Additionally or alternatively, the transmission chain 147 may include the processor 12, an PA input 162, the PA 66, a PA switch (e.g., switching circuitry) 164, a respective duplexer 146E, the frequency band switch 154, the first connection 150, a coupler (e.g., coupler circuitry) 166, the antenna switch 148, and the first antenna 55A or the second antenna 55B. Although not illustrated, the first RFFE circuitry 142 may include additional PAs 66 and/or an additional coupler coupled to the second connection 152 to form an additional transmission chain and enable the processor 12 to simultaneously transmit two signals via the first antenna 55A and the second antenna 55B. Additionally or alternatively, the second RFFE circuitry 144 includes the third receive chain 149 that may include the processor 12, an additional LNA output 168, an additional LNA switch 170, a respective LNA 82, a respective duplexer 146, an additional frequency band switch 172, and the third antenna 55C. Moreover, the second RFFE circuitry 144 may include an additional transmission chain including an additional PA input, an additional PA 66, an additional PA switch 164, a respective duplexer 146, the additional frequency band switch 172, and the third antenna 55C.

During operation of the electronic device 10, the processor 12 may transmit and/or receive signals to and from the base station 104 via the first antenna 55A, the second antenna 55B, and/or the third antenna 55C. For example, the processor 12 may simultaneously transmit and receive signals having a frequency on the first frequency band via the first antenna 55A, the transmission chain 147, and a first receive chain 143. The processor 12 may also concurrently receive signals having a second frequency within a second frequency band via the third antenna 55C and the third receive chain 149. As such, the electronic device 10 may simultaneously transmit or receive two signals to and from the base station 104 via the antennas 55. Accordingly, signal throughput of the electronic device 10 may be improved.

Additionally or alternatively, the electronic device 10 may perform a discontinuous reception (DRX) technique that provides an indication to temporarily stop operation and/or power down certain components, which may improve power usage of the device 10. For example, the processor 12 may provide the indication to the third antenna 55C to stop operation for a period of time and resume operation after the period of time. In another example, uncoupling the antenna 55 from a respective duplexer 146 may cause the antenna 55 to power down or stop signal transmissions. For example, the processor 12 may switch to transmitting and/or receiving signals via the second antenna 55B by instructing the antenna switch 148 to couple the second antenna 55B to a respective duplexer 146 to form the second receive chain 145 and both the first antenna 55A and the third antenna 55C may not be operating, which may reduce power consumption of the electronic device 10.

Returning to the first RFFE circuitry 142, the first antenna 55A and/or the second antenna 55B may be communicatively coupled to the duplexer 146 via the antenna switch 148, the first connection 150, the second connection 152, and/or the frequency band switch 154. The antenna switch 148 may include a three-pole, multiple throw switch is coupled to the first antenna 55A, the second antenna 55B, and the third antenna 55C and selects two antennas to operate simultaneously. The antenna switch 148 may include a double-throw switch, a triple-switch, or a switch with more than three-throws. In certain instances, the antenna switch 148 may include multiple throws to communicatively couple the first RFFE circuitry 142 to the second RFFE circuitry 144, couple an impedance tuner 151 to the first antenna 55A, the second antenna 55B, or the third antenna 55C, and couple at least two antennas 55 to respective duplexers 146. In other instances, the antenna switch 148 may include a three-pole, double throw switch that selects two antennas 55 to couple to respective duplexers 146. For example, the antenna switch 148 may couple the first antenna 55A to a respective duplexer 146 via the first connection 150 and the second antenna 55B to a different respective duplexer 146 via the second connection 152. the antenna switch 148 may uncouple the first antenna 55A from the respective duplexer 146 and couple the third antenna 55C to a respective duplexer 146 via the first connection 150. Still in another example, the antenna switch 148 may couple the second antenna 55B to a respective duplexer 146 via the first connection 150 and the third antenna 55C to a different respective duplexer 146 via the second connection 152. The first connection 150 and the second connection 152 may be coupled between the antenna switch 148 and the frequency band switch 154. The first connection 150 may be coupled to and/or integrated with the coupler 166. The coupler 166 may combine one or more signals for transmission by the first antenna 55A or the second antenna 55B. The coupler 166 may be inactive when a received signal is being transmitted from the first antenna 55A or the second antenna 55B to the processor 12. In certain instances, the second connection 152 may also be coupled to and/or integrated with the coupler 166 to form the additional transmission chain. The frequency band switch 154 may couple the first connection 150 and the second connection 152 to a respective duplexer 146, thereby coupling the first antenna 55A, the second antenna 55B, and/or the third antenna 55C to a respective duplexer 146.

The one or more duplexers 146 may enable the antennas 55 to transmit and/or receive signals within a frequency band for which the respective duplexer 146 is configured. In particular, the duplexers 146 may be configured to enable low band signals (e.g., signals having a frequency below 1 gigahertz (GHz)). To this end, each of the duplexers 146 may include one or more components, such as baluns, impedance devices, phase shifters, and the like, to allow certain signals having frequencies within a frequency range (e.g., frequency band) to pass through and block signals having frequencies outside of the frequency range. Additionally or alternatively, the duplexer 146 may reduce or block transmission signals from the receiver 54 and reduce or block received signals from the transmitter 52. That is, the duplexers 146 may isolate transmission signals from the receiver 54 and received signals from the transmitter 52, which may improve signal quality within the electronic device 10. For example, a duplexer 146 may allow signals on LTE Band Number 20 (Band 20) to pass through and attenuate or block signals outside of the Band 20. As used herein, Band 20 may refer to LTE Band Number 20 in accordance with Third Generation Partnership Project (3GPP) standards including uplink frequencies between 832 and 862 megahertz (MHz) and downlink frequencies between 791 and 821 MHz. However, the frequency range of LTE Band Number 20 may be different in different standards and/or as standards change over time. In addition, this disclosure refers to additional frequency bands that may be LTE Bands in accordance with the 3GPP standards, 5G Bands in accordance with the 5G NR standard, and the like. Additionally or alternatively, embodiments of this disclosure may be implemented to transmit and/or receive signals having a frequency greater than 1 GHz, such as additional LTE Bands, additional 5G Bands, 6G Bands, and so on.

As illustrated, the first RFFE circuitry 142 includes seven duplexers 146 that enable the processor 12 to transmit and/or receive signals having frequencies on a first set of frequency bands via the first antenna 55A and the second antenna 55B. For example, a first duplexer 146A may be configured to enable transmitting and/or receiving signals having a frequency within 5G Band Number 71/n105 including uplink frequencies between 663 and 703 MHz and downlink frequencies between 612 and 652 MHZ, a second duplexer 146B may be configured to enable transmitting and/or receiving signals having a frequency within 5G Band Number 12/n85 including uplink frequencies between 698 and 716 MHz and downlink frequencies between 728 and 746 MHZ, a third duplexer 146C may be configured to enable transmitting and/or receiving signals having a frequency within LTE Band Numbers 13/14 including uplink frequencies between 777 and 798 MHz and downlink frequencies between 746 and 768 MHZ, a fourth duplexer 146D may be configured to enable transmitting and/or receiving signals having a frequency within LTE Band Number 20 including uplink frequencies between 832 and 862 MHz and downlink frequencies between 791 and 821 MHZ, a fifth duplexer 146E may be configured to enable transmitting and/or receiving signals having a frequency within LTE Band Number 28F including uplink frequencies between 703 and 748 MHz and downlink frequencies between 758 and 803 MHZ, a sixth duplexer 146F may be configured to enable transmitting and/or receiving signals having a frequency within LTE Band Number 26 including uplink frequencies between 814 and 849 MHz and downlink frequencies between 859 and 894 MHZ, and a seventh duplexer 146G may be configured to enable transmitting and/or receiving signals having a frequency within LTE Band Number 8 including uplink frequencies between 880 and 915 MHz and downlink frequencies between 925 and 960 MHZ. The frequency bands are illustrative and the duplexers 146 may be configured to enable transmitting and/or receiving signals within any suitable frequency band, such as low band frequencies below 1 GHZ. As illustrated, each duplexer 146 may be a pair of duplexers 146 that enable transmitting and/or receiving signals to and from the base station 104 having a frequency within a frequency band for which the respective duplexer 146 is configured. As such, the duplexers 146 may enable the processor 12 to transmit and/or receive signals to and from the base station 104 within the first set of frequency bands via the first antenna 55A and/or the second antenna 55B.

The duplexers 146 may be coupled to switching circuitry (e.g., LNA switch 156, additional LNA switch 170) that may be coupled to or integrated with one or more receivers 54 that receive the signal from the first antenna 55A, the second antenna 55B, and/or the third antenna 55C and transmits the signal to the processor 12. For example, the first RFFE circuitry 142 may include a first set of LNAs 82 respectively coupled to the duplexers 146 that receives a signal transmits the signals to switching circuitry (e.g., LNA switch 156) that may direct the signal to an appropriate receiver 54. For example, a first LNA 82 may be coupled to the first duplexer 146A and support signals having frequencies within LTE Band Number 71 and 5G Band Number n105, a second LNA 82 may be coupled to the second duplexer 146B and support signals having frequencies within LTE Band Number 12 and 5G Band Number n85, and so on. The LNAs 82 may be coupled to the processor 12 via an LNA switch 156, a first connection 150, and a second connection 152. The first set of LNAs 82 may be coupled to the processor 12 via the LNA switch 156, an LNA output 158, 160, and/or an appropriate receiver 54. To support an additional antenna 55, the electronic device 10 may include two connections (e.g., first LNA output 158, second LNA output 160) from the LNA switch 156 to the processor 12 to provide two received signals.

As illustrated, the LNA switch 156 may couple a first LNA 82 supporting LTE Band Number 228F to the processor 12 via the first LNA output 158. The LNA switch 156 may also couple a second LNA 82 supporting LTE Band Number 20 to the processor 12 via the second LNA output 160. The first LNA 82 may transmit the received signal to the processor 12 via the first LNA output 158 and the second LNA 82 may transmit the second signal to the processor 12 via the second LNA output 160. As such, the processor 12 may receive two different signals via the first antenna 55A and the second antenna 55B, which may improve downlink throughput. In other words, the electronic device 10 may support an LTE Band Number 28+LTE Band Number 20 carrier aggregation (CA) combination using the first antenna 55A and the second antenna 55B. As such, the electronic device 10 may support downlink carrier aggregation by allowing the first RFFE circuitry 142 to simultaneously receive two signals having different frequencies via two different antennas 55.

The duplexers 146 of the first RFFE circuitry 142 may also be coupled to switching circuitry (e.g., PA switch 164) that may be coupled to or integrated with one or more transmitters 52 that transmit a signal from the processor 12 to the first antenna 55A and/or the second antenna 55B. For example, the PA 66 may be coupled to the PA input 162 to receive the signal from the processor 12. The PA 66 may also be coupled to a respective duplexer 146 via the PA switch 164 and be coupled to the first antenna 55A or the second antenna 55B via the antenna switch 148. The PA switch 164 may couple the PA 66 to a respective duplexer 146 to enable transmission of a signal having frequencies within the frequency band supported by the respective duplexer 146. As illustrated in FIG. 6, the PA switch 164 couples the PA 66 to the fifth duplexer 146E supporting transmission within LTE Band Number 28F. The fifth duplexer 146E may be coupled to the first antenna 55A via the frequency band switch 154, the first connection 150, and the antenna switch 148. As discussed herein, the first connection 150 may be coupled to or integrated with the coupler 166 that combines two signals to form the transmission signal. For example, the coupler 166 may combine a first portion of the transmission signal received from the respective duplexer 146 and a second portion of the transmission signal received from the impedance tuner. As such, the electronic device 10 may transmit the signal within the frequency band via the first antenna 55A. In some embodiments, the first RFFE circuitry 142 may include one or more additional PAs 66 to support transmission of two or more signals having different frequencies via the first antenna 55A and/or the second antenna 66B. Additionally or alternatively, the second connection 152 may be coupled to and/or integrated with an additional coupler 166. As such, the electronic device 10 may simultaneously transmit two signals having different frequencies via the two antennas 55.

The electronic device 10 may also include the third antenna 55C coupled to the second RFFE circuitry 144 for transmitting and/or receiving signals to and from the base station 104 having frequencies within a third frequency band. The third frequency band may overlap or partially overlap with the first frequency band and/or the second frequency band. The third antenna 55C may be coupled to a respective duplexer 146 via the additional frequency band switch 172. The additional frequency band switch 172 may be a double-pole, single throw switch that selects between two inputs. The inputs may include the third antenna 55C and shutdown selection. If the additional frequency band switch 172 couples the shutdown selection, then the processor 12 may not transmit and/or receive signals via the third antenna 55C. In other words, operation via the third antenna 55C may be temporarily paused.

If the additional frequency band switch 172 couples to the third antenna 55C, the processor 12 may receive signals within a frequency band via the third antenna 55C. For example, the additional frequency band switch may couple the third antenna 55C to a respective duplexer 146. The duplexers 146 of the second RFFE circuitry 144, as illustrated, may be single duplexers that isolate received signals from transmission signals. The duplexers 146 may be coupled to respective LNAs 82 that transmit the received signal to the processor 12 via the additional LNA switch 170 and the additional LNA output 168. As such, the processor 12 may receive signals via the third antenna 55C. Additionally or alternatively, the duplexers 146 of the second RFFE circuitry 144 may include pairs of duplexers that enable transmitting and/or receiving signals via the third antenna 55C. To this end, the second RFFE circuitry 144 may include additional components to form the additional transmission chain (e.g., additional PA input 162, the PA 66) to enable signal transmission via the third antenna 55C, thereby improving communication operations of the electronic device 10.

Returning to the duplexers 146, the second RFFE circuitry 144 may include an additional six duplexers 146 that enable transmitting and/or receiving signals frequencies within a second set of frequency bands via the third antenna 55C. The second set of frequency bands include frequencies within LTE Band Number 71 and 5G Band Number n105, such as uplink frequencies between 663 and 703 MHz and downlink frequencies between 612 and 652 MHz, LTE Band Number 29, such as downlink frequencies between 717 and 728 MHZ, LTE Band Numbers 28/20, such as uplink frequencies between 703 and 748 MHz as well as 832 and 862 MHz and downlink frequencies between 758 and 803 MHz as well as 791 and 821 MHZ, LTE Band Numbers Dec. 13, 2014 and 5G Band Number n85, such as four frequency ranges with uplink frequencies between 698 and 716 MHz, 777 and 787 MHz, and 788 and 798 MHZ, and 698 and 716 MHz and downlink frequencies between 728 and 746 MHZ, 746 and 758 MHZ, 758 and 768 MHz, and 728 and 746 MHZ, LTE Band Number 26, such as uplink frequencies between 814 and 849 MHz and downlink frequencies between 859 and 894 MHZ, and LTE Band Number 8, such as uplink frequencies between 880 and 915 MHz and downlink frequencies between 925 and 960 MHz. The first set of frequency bands and the second set of frequency bands illustrated in FIG. 6 are merely exemplary. That is, the duplexers 146 may enable any suitable frequency bands for transmitting and/or receiving signals to and from the base station 104. For example, the first set of frequency bands and the second set of frequency bands may include overlapping frequencies, some overlapping frequencies, or may not include any overlapping frequencies. In another example, the first set of frequency bands and/or the second set of frequency bands enabled by the duplexers 146 may include additional frequencies within additional frequency bands, such as LTE Band Number 5 including uplink frequencies between 824 and 849 MHz and downlink frequencies between 869 and 894 MHZ, LTE Band Number 12 including uplink frequencies between 698 and 716 MHz and downlink frequencies between 728 and 746 MHZ, LTE Band Number 27 including uplink frequencies between 807 and 824 MHz and downlink frequencies between 852 and 869 MHZ, LTE Band Number 41, LTE Band Number 72 including uplink frequencies between 451 and 456 MHz and downlink frequencies between 461 and 466 MHZ, and so on. Still in another example, the first set of frequency bands and/or the second set of frequency bands may include fewer frequency bands than illustrated in FIG. 6.

The first RFFE circuitry 142 and the second RFFE circuitry 144 may be coupled together via a third connection 174 and a fourth connection 176. In particular, the third connection 174 and the fourth connection 176 may be coupled between the antenna switch 148 and the additional frequency band switch 172. The first RFFE circuitry 142 may transmit a signal to the second RFFE circuitry 144 to stop operations on the third antenna 55C. For example, the fourth connection 176 may provide a transmit input (TXIN) indication at the additional frequency band switch 172 and an input connection at the antenna switch 148. Based on the transmit input indication, the additional frequency band switch 172 may selectively couple either the third antenna 55C or the shutdown selection. In this way, the electronic device 10 may enable DRX techniques, which may improve power usage of the electronic device 10 by powering down certain components of the electronic device 10 and/or cause the electronic device 10 to enter a low or reduced power or sleep mode. That is, the electronic device 10 may reduce power consumption by selectively operating the third antenna 55C. Additionally or alternatively, the second RFFE circuitry 144 may provide an indication via the third connection 174 to the first RFFE circuitry 142 of a period of time that the electronic device 10 has been communicating via the third antenna 55C.

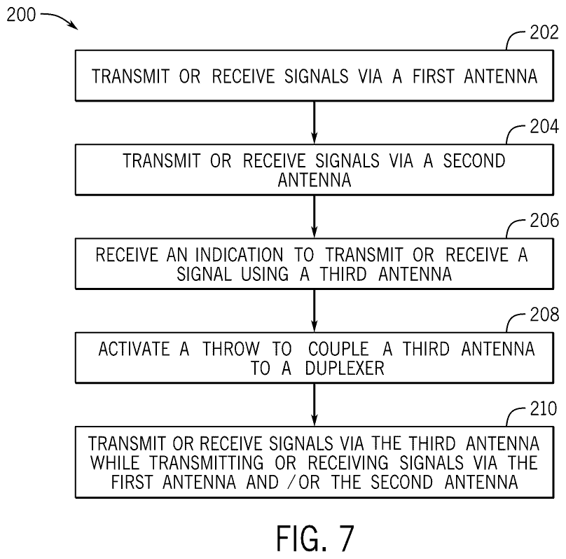

FIG. 7 is a flowchart of a method 200 for concurrently receiving two signals via at least two antennas 55 of the RFFE module 140, according to embodiments of the present disclosure. Any suitable device (e.g., a controller) that may control components of the electronic device 10, such as the processor 12, may perform the method 200. In some embodiments, the method 200 may be implemented by executing instructions stored in a tangible, non-transitory, computer-readable medium, such as the memory 14 or storage 16, using the processor 12. For example, the method 200 may be performed at least in part by one or more software components, such as an operating system of the electronic device 10, one or more software applications of the electronic device 10, and the like. While the method 200 is described using steps in a specific sequence, it should be understood that the present disclosure contemplates that the described steps may be performed in different sequences than the sequence illustrated, and certain described steps may be skipped or not performed altogether.

In process block 202, the processor 12 transmits or receives signals via a first antenna 55A. The processor 12 may activate the antenna switch 148 to selectively couple the first antenna 55A to a respective duplexer 146. The processor 12 may transmit a signal within a first frequency band enabled by the respective duplexer 146 via the first antenna 55A. In particular, the processor 12 may transmit the signal via the transmission chain 147 with the PA input 162, the PA switch 164, a respective duplexer 146, the frequency band switch 154, the first connection 150 or the second connection 152, and the antenna switch 148. In another example, the processor 12 may receive a signal within a first frequency band via the first antenna 55A and the first receive chain 143 including the antenna switch 148, the first connection 150 or the second connection 152, the frequency band switch 154, the duplexers 146, the LNA 82, and the LNA outputs 158, 160.

In process block 204, the processor 12 transmits or receives signals via a second antenna 55B. The processor 12 may activate the antenna switch 148 to selectively couple the second antenna 55B to a respective duplexer 146. The processor 12 may transmit a signal within a second frequency band via the second antenna 55B and the transmission chain 147 or receive a signal within a second frequency band via the second antenna 55B and the second receive chain 145. In certain instances, the first frequency band and the second frequency band may be different frequency bands. In other instances, the first frequency band and the second frequency band may be the same frequency band. In an example, the processor 12 may transmit a first signal via the first antenna 55A and a second signal via the second antenna 55B. In another example, the processor 12 may transmit and receive a first signal via the first antenna 55A and receive a second signal via the second antenna 55B, or vice versa. Still in another example, the processor 12 may receive a first signal via the first antenna 55A and a second signal via the second antenna 55B. As such, the processor 12 may concurrently transmit and/or receive signals via the first antenna 55A and the second antenna 55B at one time.

In process block 206, the processor 12 receives an indication to transmit or receive a signal using a third antenna 55C. For example, the processor 12 may receive an indication from the base station 104 that multiple downlink signals may be transmitted within different frequencies at the same time. In another example, the processor 12 may determine signal transmission on either the first antenna 55A and/or the second antenna 55B may be poor quality (e.g., have a signal quality less than a threshold signal quality) and determine that signal transmission on the third antenna 55C may improve the signal quality. In certain instances, the processor 12 may determine that communications within a first frequency band and a second frequency band via the first antenna 55A and the second antenna 55B may be occurring. As such, the processor 12 may determine additional operations to be performed prior performing signal transmission using the third antenna 55C.

In process block 208, the processor 12 activates a throw to couple a third antenna 55C to a duplexer 146. For example, the antenna switch 148 may uncouple the first antenna 55A from its respective duplexer 146 or uncouple the second antenna 55B from its respective duplexer 146. That is, the processor 12 may instruct the antenna switch 148 activate a throw to uncouple either the first antenna 55A or the second antenna 55B from its respective duplexer 146. The processor 12 may then instruct the antenna switch 148 to activate the same throw to couple the third antenna 55C to a respective duplexer 146.

In process block 210, the processor 12 transmits or receives signals via a third antenna 55C while transmitting or receiving signals via the first antenna 55A and/or the second antenna 55B. That is, the processor 12 may transmit to and/or receive signals from the base station 104 via the third antenna 55C using the additional transmission chain and/or the third receive chain 149. For example, the processor 12 may receive signals from the base station 104 within the first frequency band via the first antenna 55A, transmit signals to the base station 104 within the second frequency band via the second antenna 55B, and both transmit and receive signals within the first frequency band and the second frequency band via the third antenna 55C. In another example, processor 12 may receive signals within a first frequency band via the first antenna 55A, receive signals within a second frequency band via the second antenna 55B, and receive signals within the first frequency band and the second frequency band via the third antenna 55C. In this manner, the method 200 enables the electronic device 10 to transmit and/or receive signals from the base station 104 having frequencies within two different frequency bands at one time, thereby improving signal throughput. In particular, the method 200 enables the electronic device 10 to concurrently receive signals from the base station 104 via at least two antennas 55, thereby improving downlink (e.g., received signal) throughput and/or enable downlink carrier aggregation. Additionally or alternatively, the processor 12 may transmit signals within a first frequency band via the first antenna 55A, transmit signals within a second frequency band via the second antenna 55B, and transmit signals within the first frequency band and the second frequency band via the third antenna 55C. As such, the method 200 enables the electronic device 10 to concurrently transmit signals to the base station 104 via at least two antennas 55, which may improve uplink (e.g., transmission signal) throughput.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. An electronic device, comprising:
a first antenna and a second antenna;
a first receiver comprising a first low noise amplifier;
a second receiver comprising a second low noise amplifier;
a first duplexer coupled to the first low noise amplifier;
a second duplexer coupled to the second low noise amplifier;
a switch coupled to the first antenna and the second antenna; and
processing circuitry configured to
cause the switch to couple the first duplexer to the first antenna,
cause the switch to couple the second duplexer to the second antenna,
cause the first receiver to receive a first signal having a first frequency within a first frequency band via the first antenna, and
cause the second receiver to receive a second signal having a second frequency within a second frequency band via the second antenna while the first receiver receives the first signal.

2. The electronic device of claim 1, comprising:
a third antenna, wherein the switch is coupled to the third antenna;
a third receiver comprising a third low noise amplifier; and
a third duplexer coupled to the third low noise amplifier.

3. The electronic device of claim 2, wherein the processing circuitry is configured to
cause the switch to uncouple the first duplexer from the first antenna, and
couple the third receiver to receive a third signal having a third frequency within a third frequency band via the third antenna while the second receiver receives the second signal.

4. The electronic device of claim 2, wherein the processing circuitry is configured to
cause the switch to uncouple the first duplexer from the first antenna, and
couple the third receiver to receive a third signal having the second frequency within the second frequency band via the third antenna while the second receiver receives the second signal.

5. The electronic device of claim 1, comprising a transmitter comprising a power amplifier coupled to the first duplexer or the second duplexer.

6. The electronic device of claim 5, wherein the power amplifier is coupled to the first duplexer, the processing circuitry is configured to cause the transmitter to receive a third signal having a third frequency within a third frequency band via the first antenna, while the first receiver the first signal and the second receiver receives the second signal.

7. The electronic device of claim 6, wherein the third frequency band and the first frequency band are the same.

8. The electronic device of claim 1, comprising a frequency band switch and a plurality of duplexers including the first duplexer and the second duplexer, the frequency band switch configured to couple the first antenna and the second antenna to the first duplexer and the second duplexer.

9. The electronic device of claim 1, wherein the switch comprises a three-pole, double-throw switch.

10. A method for wireless communications, comprising:
causing, via processing circuitry, an antenna switch to couple a first antenna to a first duplexer configured to enable transmission or reception of signals having a first frequency within a first frequency band;
causing, via the processing circuitry, the antenna switch to couple a second antenna to a second duplexer configured to enable transmission or reception of signals having a second frequency within a second frequency band;
receiving, via the processing circuitry and the first antenna, a first signal having the first frequency; and
receiving, via the processing circuitry and the second antenna, a second signal having the second frequency while receiving the first signal.

11. The method of claim 10, comprising transmitting, via the processing circuitry and the first antenna, a third signal having the first frequency while receiving the first signal and the second signal.

12. The method of claim 10 comprising:
transmitting, via the processing circuitry and the first antenna, a third signal having the first frequency while receiving the first signal and the second signal; and
transmitting, via the processing circuitry and the second antenna, a fourth signal having the second frequency while receiving the first signal and the second signal and transmitting the third signal.

13. The method of claim 10, comprising:
causing, via the processing circuitry, the antenna switch to uncouple the first antenna from the first duplexer;
causing, via the processing circuitry, the antenna switch to couple a third antenna to a third duplexer configured to enable transmission or reception of signals having a third frequency within a third frequency band; and
transmitting, via the processing circuitry and the third antenna, a third signal having the third frequency while receiving the second signal.

14. The method of claim 10, comprising:
causing, via the processing circuitry, the antenna switch to couple a third antenna to a third duplexer configured to enable transmission or reception of signals having a third frequency within a third frequency band and uncouple the second antenna from the second duplexer in response to receiving an indication to perform operations using the third antenna; and
receiving, via the processing circuitry and the third antenna, a third signal having the third frequency within the third frequency band while receiving the second signal via the second antenna.

15. The method of claim 14, comprising causing, via the processing circuitry, the antenna switch to uncouple the third antenna based on an indication to power down one or more components.

16. The method of claim 14, comprising transmitting, via the processing circuitry and the third antenna, a fourth signal having the third frequency within the third frequency band while receiving the second signal via the second antenna and transmitting the fourth signal via the third antenna.

17. An electronic device, comprising:
two or more antennas;
a plurality of duplexers coupled to the two or more antennas and configured to enable transmission or reception of signals within a first frequency band and a second frequency band;
at least one receiver coupled to at least one low noise amplifier;
a switch coupled to the two or more antennas; and
processing circuitry configured to
cause the switch to couple a first duplexer of the plurality of duplexers to a first antenna of the two or more antennas,
cause the switch to couple a second duplexer of the plurality of duplexers to a second antenna of the two or more antennas, and
cause the at least one receiver to concurrently receive a first signal having a first frequency within the first frequency band via the first antenna and a second signal having a second frequency within the second frequency band via the second antenna.

18. The electronic device of claim 17, wherein the processing circuitry is configured to
cause the switch to uncouple the first duplexer from the first antenna, and
cause the switch to couple a third duplexer of the plurality of duplexers to a third antenna of the two or more antennas in response to receiving an indication to perform operations using the third antenna.

19. The electronic device of claim 18, wherein the processing circuitry is configured to cause the at least one receiver to receive a third signal having a third frequency within a third frequency band via the third antenna and a fourth signal having a fourth frequency via the third antenna while receiving the second signal having the second frequency via the second antenna.

20. The electronic device of claim 17, comprising a transmitter comprising a power amplifier, the processing circuitry configured to cause the transmitter to transmit a third signal having the first frequency via the first antenna or the second antenna while the at least one receiver is simultaneously receiving the first signal and the second signal.
